(19) United States
(12) Patent Application Publication
(10) Pub. No.: US 2012/0246483 A1
(43) Pub. Date: Sep. 27, 2012

(54) Authentication System With Time Attributes

(76) Inventor: Netanel Raisch, Psagot (IL)

(21) Appl. No.: 13/072,557

(22) Filed: Mar. 25, 2011

(51) Int. Cl. H04L 9/32

(52) U.S. Cl. 713/178

(57) ABSTRACT

An apparatus for managing access to a computing resource, comprises a clock configured to associate a datum arrival time with an authentication datum. The clock is further configured to calculate a datum elapsed time between a first datum arrival time associated with a first authentication datum and a second datum arrival time associated with a second authentication datum. The apparatus also comprises an authentication module configured to receive at least the first authentication datum and the second authentication datum; compare the datum elapsed time with a threshold elapsed time; and selectively provide access to a computing resource based at least in part upon successfully matching the received first authentication datum with a stored first authentication datum, successfully matching the received second authentication datum with a stored second authentication datum, and determining that the datum elapsed time exceeds the datum threshold time.

### TECHNICAL FIELD

The disclosed apparatuses and processes are generally directed at the field of security of electronic information and more specifically directed at the field of controlling access to computing resources.

### SUMMARY

An apparatus for managing access to a computing resource can comprise a clock configured to associate a datum arrival time with an authentication datum. The clock can be further configured to calculate a datum elapsed time between a first datum arrival time associated with a first authentication datum and a second datum arrival time associated with a second authentication datum. The apparatus can also comprise an authentication module configured to receive at least the first authentication datum and the second authentication datum; to compare the datum elapsed time with a threshold elapsed time; and to selectively provide access to a computing resource based at least in part upon successfully matching the received first authentication datum with a stored first authentication datum, successfully matching the received second authentication datum with a stored second authentication datum, and determining that the datum elapsed time exceeds the datum threshold time.

Each authentication datum can be an authentication datum selected from the group consisting of an alphanumeric character, an alphanumeric string, a binary string, a data file, and a data object. The computing resource can be a resource selected from the group consisting of a local computer, a remote computer, a mobile computing device, a network management device, a software program, a software-based service, a data store, and a file.

The computer-implemented method can further comprise receiving a first request to access the computing resource; determining a first access request time associated with the first request to access the computing resource; receiving a second request to access the computing resource; determining a second access request time associated with the second request to access the computing resource; calculating an access request elapsed time between the second access request time associated with the second request to access the computing resource and the first access request time associated with the first request to access the computing resource; and selectively denying access to the computing resource based at least in part upon determining that the access request elapsed time fails to exceed an access request threshold time.

Additionally, the computer-implemented method can further comprise detecting whether the first authentication datum originated from a stored credential system. At least one of the steps of determining a first time associated with the first authentication datum; determining a second time associated with the second authentication datum; calculating a first datum elapsed time between the second time associated with the second authentication datum and the first time associated with the first authentication datum; and selectively providing access to a computing resource based at least in part upon successfully matching the received first authentication datum with a stored first authentication datum, successfully matching the received second authentication datum with a stored second authentication datum, and comparing the first datum elapsed time with a datum threshold time can be performed subsequent to a first denial of access to the computing resource.

The computer-implemented method can further comprise receiving a third authentication datum; determining a third time associated with the third authentication datum; calculating a second datum elapsed time between the third time associated with the third authentication datum and the second time associated with the second authentication datum; wherein the step of selectively providing access to a computing resource includes the step of determining whether the second datum elapsed time is greater than the datum threshold time.

Each authentication datum can be an authentication datum selected from the group consisting of an alphanumeric character, an alphanumeric string, a binary string, a data file, and a data object. The computing resource can be a resource selected from the group consisting of a local computer, a remote computer, a mobile computing device, a network management device, a software program, a software-based service, a data store, and a file.

The computer-implemented can further comprise receiving a first request to access the computing resource; determining a first access request time associated with the first request to access the computing resource; receiving a second request to access the computing resource; determining a second access request time associated with the second request to access the computing resource; calculating an access request elapsed time between the second access request time associated with the second request to access the computing resource and the first access request time associated with the first request to access the computing resource; and selectively denying access to the computing resource based at least in part upon determining that the access request elapsed time fails to exceed an access request threshold time. The computer-implemented method can further comprise detecting whether the first authentication datum originated from a stored credential system.

At least one of the steps of determining a first time associated with the first authentication datum; determining a second time associated with the second authentication datum; determining a third time associated with the third authentication datum; calculating a first datum elapsed time between the second time associated with the second authentication datum and the first time associated with the first authentication datum; calculating a second datum elapsed time between the third time associated with the third authentication datum and the second time associated with the second authentication datum; determining whether the first datum elapsed time is greater than a datum threshold time; and determining whether the second datum elapsed time is greater than the datum threshold time can be performed subsequent to a first denial of access to the computing resource.

A computer-implemented method for creating authentication credentials to access a computing resource can comprise detecting activation of an input key; obtaining a data value assigned to the input key; determining a duration of activation of the input key; and associating the duration of activation of the input key with the data value assigned to the input key. The computer-implemented method can further comprise repeating, one or more times, the steps of detecting activation of an input key; obtaining a data value assigned to the input key; determining a duration of activation of the input key; and associating the duration of activation of the input key with the data value assigned to the input key to create a complete set of authentication credentials.

The data value assigned to the input key can be an alphanumeric character. Determining a duration of activation of the input key can include counting repeated occurrences of the alphanumeric character and calculating the duration of activation using at least a repeat rate of keyed data input. Determining a duration of activation of the input key can include using a clock to calculate a time interval between activation of the input key and deactivation of the input key.

An apparatus for managing access to a computing resource can comprise a clock configured to associate a datum arrival time with an authentication datum and further configured to calculate a datum elapsed time between a first datum arrival time associated with a first authentication datum and a second datum arrival time associated with a second authentication datum; an authentication module configured to receive at least the first authentication datum and the second authentication datum, compare the datum elapsed time with a threshold elapsed time, and selectively provide access to a computing resource based at least in part upon successfully matching the received first authentication datum with a stored first authentication datum, successfully matching the received second authentication datum with a stored second authentication datum, and determining that the datum elapsed time exceeds the datum threshold time. Each authentication datum can be an authentication datum selected from the group consisting of an alphanumeric character, an alphanumeric string, a binary string, a data file, and a data object. The computing resource can be a resource selected from the group consisting of a local computer, a remote computer, a mobile computing device, a network management device, a software program, a software-based service, a data store, and a file.

The clock can be further configured to associate an access request time with a request to access the computing resource and calculate an access request elapsed time between a first access request time associated with a first access request and a second access request time associated with a second access request and the authentication module can be further configured to selectively deny access based at least in part upon a comparison of the access request elapsed time with an access request threshold time.

The authentication module can be further configured to determine whether at least one of the first authentication datum and the first access request originated from a stored credential system.

An apparatus for creating authentication credentials can comprise an authentication module configured to create a set of authentication credentials by detecting activation of an input key; obtaining a data value assigned to the input key; determining a duration of activation of the input key; associating the duration of activation of the input key with the data value assigned to the input key; and repeating, zero or more times, the steps of detecting, obtaining, determining, and associating, and storing a set of authentication credentials that include at least one data value assigned to the input key and an associated duration of activation.

The apparatus can further comprise a user interface configured to display both the data value assigned to the input key and the duration of activation associated with the data value. Also, the apparatus can further comprise a user interface configured to display both an obfuscation symbol in place of the data value assigned to the input key and the duration of activation associated with the data value.

A computer-implemented method for accessing a computing resource can comprise sending a first authentication datum that includes a first value:time pair; sending a second authentication datum that includes a second value:time pair; and receiving an access indicator that indicates whether access is granted to a computing resource; wherein the access indicator can be created based at least in part upon calculating a first datum elapsed time the time of the second value:time pair and the time of the first value:time pair; successfully matching the received first authentication datum with a stored first authentication datum, successfully matching the received second authentication datum with a stored second authentication datum, and comparing the first datum elapsed time with a datum threshold time.

Each value portion of the first value:time pair and the second value:time pair can be a value selected from the group consisting of an alphanumeric character, an alphanumeric string, a binary string, a data file, and a data object. The computing resource can be a resource selected from the group consisting of a local computer, a remote computer, a mobile computing device, a network management device, a software program, a software-based service, a data store, and a file.

An apparatus for accessing a computing resource can comprise an authentication module configured to send a first authentication datum that includes a first value:time pair and a second authentication datum that includes a second value:time pair; and further can be configured to receive an access indicator that indicates whether access is granted to a computing resource; wherein the access indicator is created based at least in part upon calculating a first datum elapsed time the time of the second value:time pair and the time of the first value:time pair; successfully matching the received first authentication datum with a stored first authentication datum, successfully matching the received second authentication datum with a stored second authentication datum, and comparing the first datum elapsed time with a datum threshold time.

Each value portion of the first value:time pair and the second value:time pair can be a value selected from the group consisting of an alphanumeric character, an alphanumeric string, a binary string, a data file, and a data object. The computing resource is a resource selected from the group consisting of a local computer, a remote computer, a mobile computing device, a network management device, a software program, a software-based service, a data store, and a file.

### BRIEF DESCRIPTON OF THE DRAWINGS

FIG. 1 is a system block diagram of a timed authentication system.

FIG. 2A is a system block diagram of a timed authentication credential creation system.

FIG. 2B is a system block diagram of a networked timed authentication credential creation system.

FIG. 3A is a system block diagram of a graphical user interface for creating access credentials.

FIG. 3B is a system block diagram of a graphical user interface for creating access credentials.

FIG. 4A is a flow diagram for a method of authenticating a user of a computing resource.

FIG. 4B is a flow diagram for a method of authenticating a user of a computing resource.

FIG. 5 is a flow diagram for a method of authenticating a user of a computing resource.

FIG. 6 is a flow diagram for a method of creating authentication credentials with time attributes.

FIG. 7 is a flow diagram for a method of creating authentication credentials with time attributes.

### DETAILED DESCRIPTION

The devices, methods, and systems disclosed and described in this document can be used to manage or control access to a variety of computing resources. For ease of description, some of the examples included in this document focus on a system arranged in a client-server architecture and sometimes reference various communication protocols that can be used in a network protocol stack model. Those of ordinary skill in this art area will recognize from reading this description that the devices, methods, and systems described can be applied to, or easily modified for use with, other types of equipment, other protocols, and at other layers in a communication protocol stack. Descriptions of components presented solely as part of a client-server architecture do not imply that other architectures, such as peer-to-peer or distributed architectures, could not be used. To the contrary, possible modifications will be apparent to people of ordinary skill in this area after reading disclosures in this document. Like reference numerals are intended to refer to the same or similar components.

Throughout this disclosure, references to components or modules generally refer to items that logically can be grouped together to perform a function or group of related functions. Components and modules can be implemented in software, hardware, or a combination of software and hardware. The term software is used expansively to include not only executable code, but also data structures, data stores and computing instructions in any electronic format, firmware, and embedded software. The term information is used expansively and includes a wide variety of electronic information, including but not limited to machine-executable or machine-interpretable instructions; content such as text, video data, and audio data, among others; and various codes or flags. The terms information and content are sometimes used interchangeably when permitted by context. It should be noted that although for clarity and to aid in understanding some examples discussed below might describe specific features or functions as part of a specific component or module, or as occurring at a specific layer of a computing device (for example, a hardware layer, operating system layer, or application layer), those features or functions may be implemented as part of a different component or module or at a different layer.

The examples discussed below are examples only and are provided to assist in the explanation of the systems and methods described. None of the features or components shown in the drawings or discussed below should be taken as mandatory for any specific implementation of any of these systems or methods unless specifically designated as mandatory. For ease of reading and clarity, certain components, modules, or methods may be described solely in connection with a specific figure. Any failure to specifically describe a combination or subcombination of components should not be understood as an indication that any combination or subcombination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

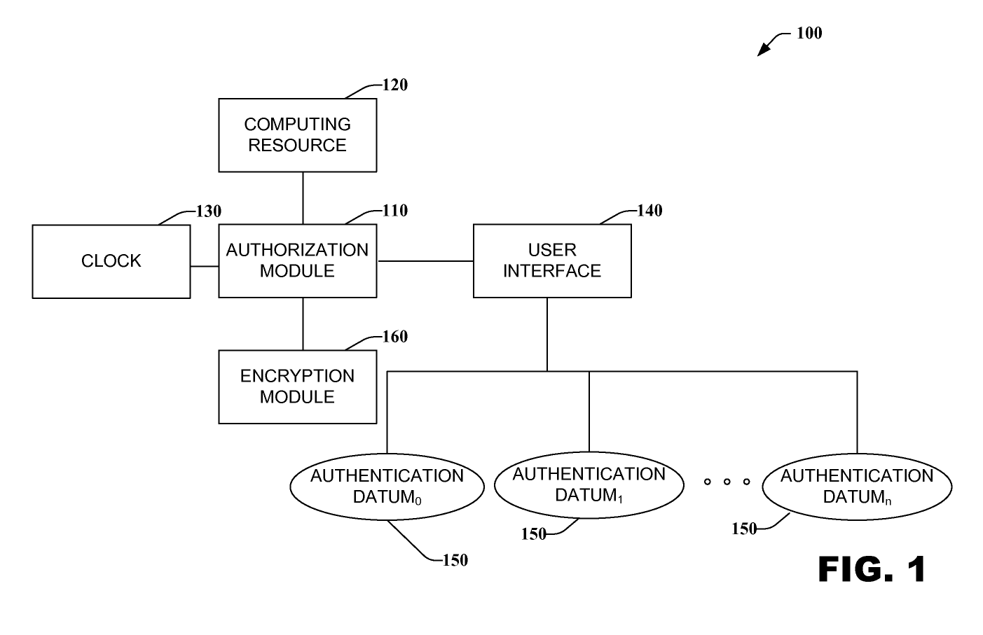

FIG. 1 is a system block diagram of a timed authentication system 100. The timed authentication system 100 can be used to control access to a wide variety of computing resources. Specifically, it can be used to control access in systems that can use username-password systems or other types of challenge-response authentication systems. Time attributes of the system can be used to ensure that a set of access credentials were submitted by a human user as opposed to being generated by a machine as part of an automated attack, such as a brute force attempt to guess a username and password of an authorized user of a computing resource or other attempt to gain access to a computing resource. Enforcement of various time constrains in the timed authentication system 100 can protect against such automated attacks by extending the time required to submit a set of access credentials, thus making some types of automatic and brute force attacks infeasible because of the increased amount of time required to explore the search space needed to discover values of authentic access credentials.

The timed authentication system 100 can include an authentication module 110. The authentication module 110 can perform a variety of processing tasks for checking authentication credentials that are presented as part of a request to access a computing resource 120. These tasks can include checks of authentication credentials, including character and string matching and time information analysis.

The computing resource 120 can be coupled to the authentication module 110. The exact nature of the coupling can vary according to particular details of the computing resource 120 to which the authentication module 110 is coupled. The computing resource 120 can be local to the platform on which the authentication module 110 is located or can be remote from the authentication module 110. The computing resource 120 can be any file, data, data store, process, procedure, program, code, module, application, device, machine, system, or computer for which a challenge-response, username-password, or similar system can be used to control access. Specifically, the computing resource 120 can be an electronic file, an electronic document, a database, an executable program, a website, a remote computing platform, a controller for various types of machinery including automobiles and other vehicles, heavy equipment, presses, lathes, or other machinery.

A clock 130 can provide time information to the authentication module 110. In various implementations, as necessary or desired, the clock 130 can provide time information in at least one of a variety of accepted or standardized formats or can provide time information in a custom-created format for a specific application. Information supplied by the clock 130 can be in the form of terrestrial time or epoch time. Among the formats that can be used is the international standard date and time format defined by ISO 8601:2004, POSIX time, coordinated universal time (UTC), and international atomic time (TAI), among others. The clock 130 can be adjusted using the network time protocol (NTP) version 4, or another suitable means.

A user interface 140 can be coupled to the authentication module 110. A human or machine user can access the authentication module 110 through the user interface 140. In the case where the user is a machine or computing process or device, the user interface 140 can provide a communication channel to the authentication module 110.

The user interface 140 can additionally or alternatively be a human-computer interface. Among the types of suitable human-computer interfaces that can be used are a text-based interface, a terminal, a shell, a graphical user interface (GUI), an audio interface, a Braille interface, and a web interface, among others.

The user interface 140 can accept input of an authentication datum 150. Each authentication datum 150 can be presented to the authentication module 110 to authenticate a user seeking access to the computing resource 120. The authentication datum 150 can be a single character, piece of data, a file, a username, a password, a piece of time information, or another suitable piece of information that can be used to authenticate identity or permissions of a user of the computing resource 120. One or more authentication datum can be associated with time information from the clock 130 and can be combined with one or more other authentication datums, alone or in any combination, to create a set of authentication credentials (not shown).

An encryption module 160 can be coupled with the authentication module 110 to provide cryptographic functions. The authentication module 110 can use the encryption module 160 to convert an encrypted version of an authentication datum 150 to a plaintext version. Details of the encryption module 160 can vary depending upon specifics of the architecture and system with which the timed authentication system 100 is used. For example, in a networked environment, the encryption module 160 can be configured to support communications encoded according to version 1.1 of the secure hypertext transfer protocol (HTTPS/1.1) or the IP Security Protocol (IPSec), or another suitable security protocol, as desired for a specific implementation. In local and networked environments, the encryption module 160 can be configured to support a variety of types of ciphers, including a private key cipher, a symmetric private key cipher, a public key cipher, and an elliptic curve cipher, among others. Specifically, the encryption module 160 can be configured to use the Advanced Encryption Standard (AES), the Data Encryption Standard (DES), triple DES (3DES), or another suitable cipher.

Each authentication datum 150 can have a variety of specific formats depending upon particular details of the authentication scheme used. Generally, each authentication datum 150 includes a value:time pair. The value portion of the pair can include a value of a character of a password, an authentication file, or other data or information that can be used to authenticate a user of the computing resource 120. The time portion of the pair can include a time stamp that indicates a time of creation of the datum, a time of transmission of the authentication datum 150, or a duration. One or more pairs can be grouped to create a set of authentication credentials. Table 1 below depicts a possible set of authentication credentials created by grouping value:time

TABLE 1

| Value | Time |
|---|---|
| P | 2011030114225709 |
| 4 | 2011030114225834 |
| s | 2011030114225950 |
| s | 2011030114230055 |
| w | 2011030114230204 |
| 0 | 2011030114230314 |
| r | 2011030114230415 |
| d | 2011030114230536 |
| ! | 2011030114230636 |

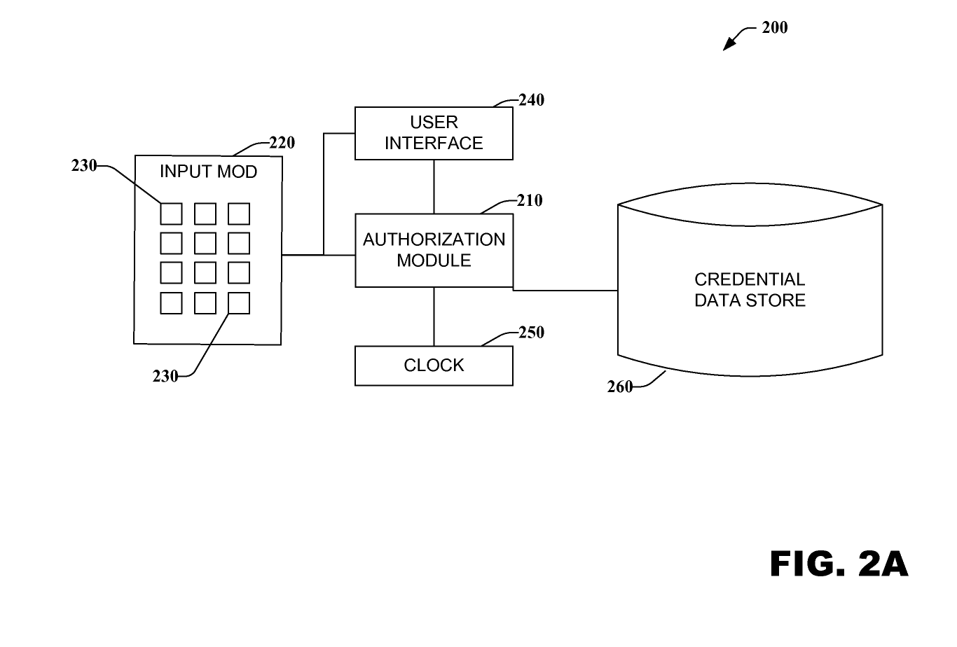

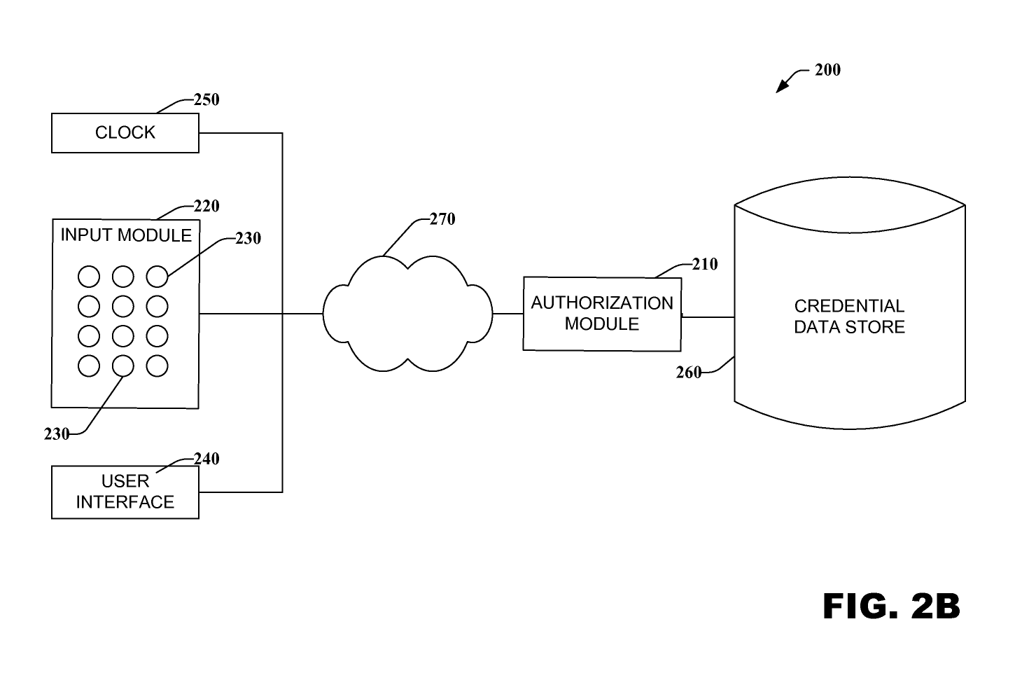

FIG. 2A is a system block diagram of a timed authentication credential creation system 200. The timed authentication credential creation system 200 can be used to create authentication credentials with time attributes for use in a timed authentication system, such as the timed authentication system 100 shown in FIG. 1.

The timed authentication credential creation system 200 can include an authentication module 210. The authentication module 210 can create authentication credentials that can include at least one authentication datum (not shown). An input device 220 can be coupled to the authentication module 210 and can be used to enter each value of each authentication datum used to create a set of authentication credentials. The input module 220 can include a set of input keys 230. Each of the input keys 230 can be mapped to an alphanumeric character encoded in a format such as the American Standard Code for Information Interchange (ASCII), Unicode, or another suitable format.

The input module 220 can be a physical input device such as a 102 key keyboard arranged in a QWERTY or DVORAK layout, among other layouts, a numeric keypad, a stenographic keyboard, or a Braille keyboard, among others. Alternatively, the input module 220 and input keys 230 can be implemented in software and displayed on-screen as a virtual input device. In such an implementation, the input module 220 and the input keys 230 can be part of a user interface 240 or can be a separate component.

The authentication module 210 can obtain time information from a clock 250. The clock 250 can be implemented in a similar manner as the clock 130 of FIG. 1 or can be a different suitable clock. A credential data store 260 can store created authentic authentication credentials (not shown) that can comprise at least one authentication datum (not shown) against which submitted authentication credentials can be compared and verified. The exact method of comparison will vary according to implementation details of the authentication datum. For example, if the format of the authentication datum includes an ASCII or Unicode value, then a value of the ASCII or Unicode portion of a submitted authentication datum can be compared against a value of an authentication datum stored in the credential data store 260 and known to be authentic. If the format of the authentication datum includes a string, then the string of a submitted authentication datum can be compared to a string of an authentication datum stored in the credential data store 260 and known to be authentic using a command such as the string compare function of many programming languages such as C, C++, Java, and C#, among others. For other types of data, various methods can be used to verify attributes and values of the data portion of a submitted authentication datum against known authentic values stored in the credential data store 260.

FIG. 2B is a system block diagram of the timed authentication credential creation system 200 in a networked environment. In this example, the authentication module 210 and the credential data store 260 can be accessed by the input module 220 over a network 270. The network 270 can be any suitable data network or internetwork running a variety of communication protocols or combinations of protocols. Specifically, the network 270 can be a circuit-switched network using asynchronous transfer mode (ATM), a packet-switched network running the TCP/IP suite of protocols, a cellular network using code division multiple access (CDMA or CDMA:2000), global system for mobile communications (GSM), or one of the 3G protocols, a wireless network running one or more of the IEEE 802.11x family of protocols, or another suitable network, including networks running on protocols currently in development or yet to be developed.

It should be noted that in this example, the clock 250 is depicted as local to the input module 220 and the user interface 240. The clock 250 could alternatively be remote from these components. In this case, various methods, such as using the sequencing scheme available in the TCP/IP protocol, can be employed to deal with latency or out-of-order delivery problems that can occur in some network. It should also be noted that the network architecture shown can be a client-server architecture, a peer-to-peer (P2P) architecture, or another suitable architecture. Other configurations, including configurations using multiple clocks, can also be used.

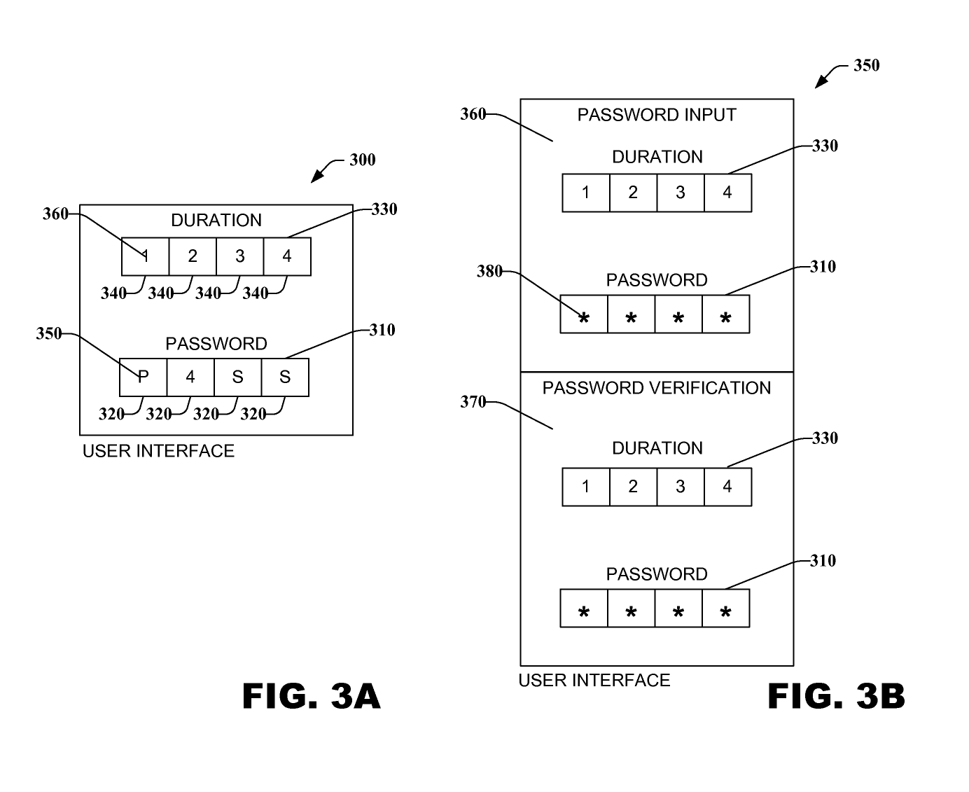

FIG. 3A is a system block diagram of a graphical user interface (GUI) 300 for creating access credentials. An input device (not shown), such as the input module 220 shown in FIGS. 2A and 2B, can send data values to the GUI 300 for display in appropriate areas of the GUI 300. The GUI 300 can include a password pane 310 that itself can include one or more password fields 320. Each of the password fields 320 can display a character that can be used to construct a password.

The GUI 300 also can include a duration pane 330. The duration pane 330 can include one or more duration fields 340. Each of the duration fields 340 can be mapped to one of the password fields 320 and vice-versa. For example, as shown in FIG. 3A, the first password field 320 that includes the character “P” is mapped to the first duration field 340 that includes the character “1”. The character “1” in the first duration field 340 can indicate that the character “P” in the first password field 320 was input from a device that was selected for one second.

FIG. 3B is a system block diagram of a graphical user interface (GUI) 350 for creating access credentials. An input device (not shown) can send data values to the GUI 350 for display in appropriate areas of the GUI 350. Among the input devices that can be used is the input module 220 shown in FIGS. 2A and 2B.

The GUI 350 can include a password input pane 360. The password input pane 360 can be implemented in a manner similar to the GUI 300. In this example, character 380 in the first password field 310 is shown as an asterisk to obfuscate and protect the actual value of the character that was input. A password validation pane 370 can also be constructed similar to the GUI 300 and can be used to validate input to the password input pane 360 by requiring a user to enter data that was previously entered into the password input pane 360 into the password validation pane 370 and checking the two sets of data to ensure that the data matches before using this input data to create a set of authentication credentials.

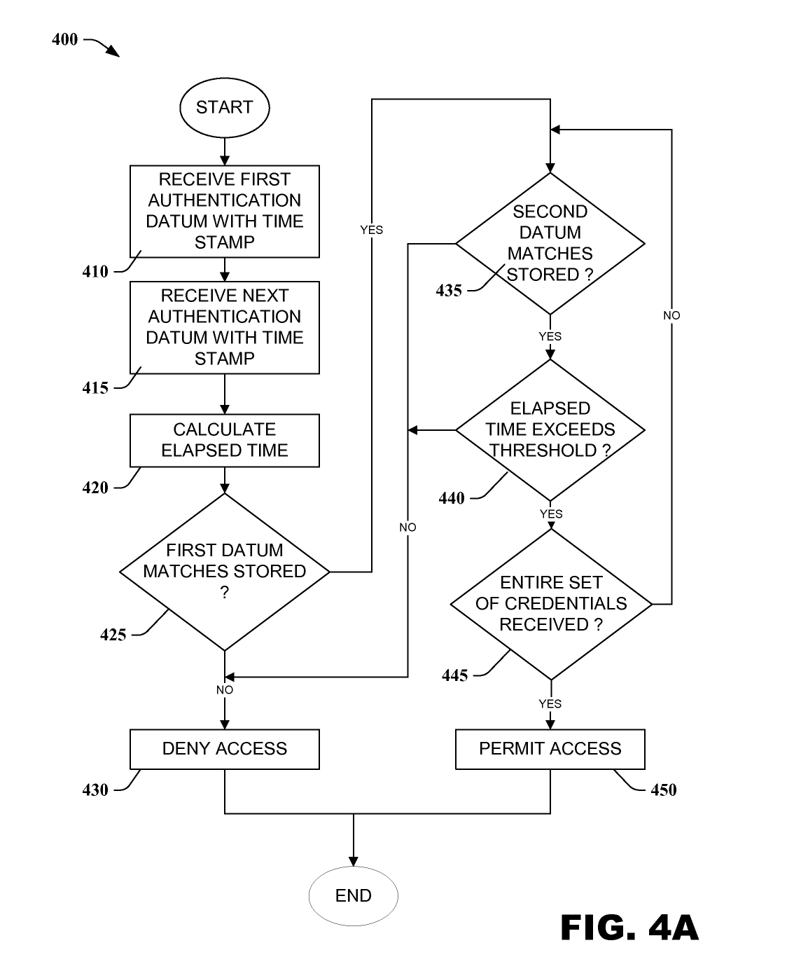

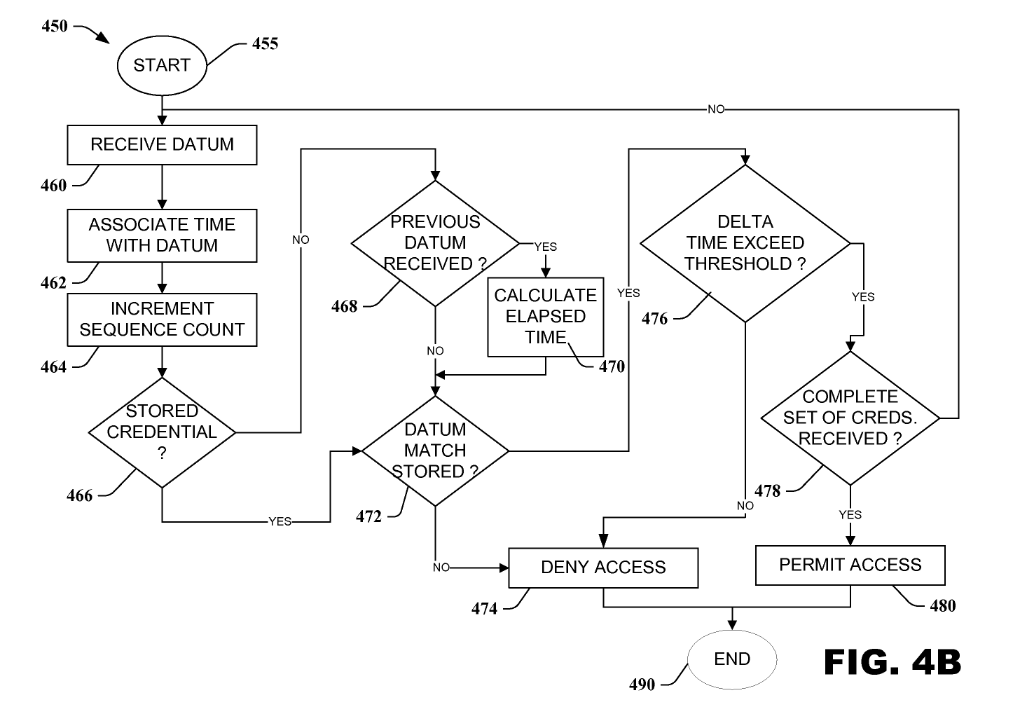

FIG. 4A is a flow diagram for a method 400 of authenticating a user of a computing resource. Execution of the method 400 begins at START block 405 and continues to process block 410. At process block 410 a first authentication datum is received. In a username-password system, this authentication datum can be formatted as a value:time pair. The value portion of the datum can be a single character of a password, a single word of a passphrase, or another datum whose value can be ascertained and matched against a known authentic value. The time portion of the pair can be a time stamp created by a local machine or a remote machine or can be a duration indicator. The duration indicator can be an indicator of the length of time that a key on an input device was depressed or otherwise activated or can be an indicator of the length of time between entry of a first character of a word in a passphrase and a last character of that word.

Processing continues to process block 415 where a next authentication datum is received. As with the first authentication datum, the next authentication datum can also be formatted as a value:time pair. At process block 420, the elapsed time between time stamps of the first authentication datum and the next authentication datum is calculated by taking the absolute value of the difference between values of the time stamps. The step described here at process block 420 can be omitted if the time portion of the datum references a duration.

Processing of the method 400 continues to decision block 425 where a determination is made whether the value portion of the first authentication datum matches a known authentic value of the first authentication datum that can be stored locally or remotely. If the determination is NO, then access to the computing resource is denied at process block 430. Processing then terminates at END block 432.

If the determination made at decision block 425 is YES, processing continues to decision block 435 where a determination is made whether the value portion of the next authentication datum received at process block 415 matches a known authentic value of the first authentication datum that can be stored locally or remotely. If the determination is NO, then access to the computing resource is denied at process block 430. Processing then terminates at END block 432. If the determination made at decision block 435 is YES, processing continues to decision block 440.

At decision block 440, a determination is made whether the elapsed time calculated at process block 420 exceeds a threshold value. This threshold value can be determined by an administrator of the computing resource for which access is sought. One possible threshold value is one second. Fractions of seconds, multiple seconds, or other periods of time can also be used. If the determination is NO, then access to the computing resource is denied at process block 430. Processing then terminates at END block 432.

If the determination made at decision block 440 is YES, processing continues to decision block 445 where a determination is made whether an entire set of access credentials has been received. This determination can be made by counting the number of authentication datums received and comparing that number to the number of stored and known authentic datums. Additionally or alternatively, this determination can be made by detecting a termination character such as an end of line (EOL) character, an end of file (EOF) character, a NULL character, a line feed (LF) character, a carriage return (CR) character, a combined LF/CR character, or another suitable terminator.

If the determination made at decision block 445 is NO, processing returns to process block 415. If the determination is YES, processing continues to process block 447 where access to the computing resource is permitted. Processing of the method 400 terminates at END block 432.

FIG. 4B is a flow diagram for a method 450 of authenticating a user of a computing resource. Execution of the method 450 begins at START block 455 and continues to process block 460. At process block 460 an authentication datum is received. In a username-password system, this authentication datum can be a single character of a password, a single word of a passphrase, or another datum whose value can be ascertained and matched against a known authentic value. At process block 460, time information is associated with the authentication datum. The time information can be a time stamp or can be a duration indicator. The duration indicator can be an indicator of the length of time that a key on an input device was depressed or otherwise activated or can be an indicator of the length of time between entry of a first character of a word in a passphrase and a last character of that word.

Processing continues to process block 464 where a sequence counter used to manage receipts of authentication datums is incremented. Processing continues to decision block 466 where a determination is made whether the datum received at process block 466 originated from an automated login procedure such as a username-password storage feature found in many web browsers or other software applications. If this determination is NO, processing continues to decision block 468 where a determination is made whether a previous authentication datum has been received. If the determination made at decision block 468 is YES, processing continues to process block 470 where elapsed time between received authentication datums is calculated by calculated the absolute value of the difference between times associated with each received authentication datum.

If the determination made at decision block 466 is YES, processing continues to decision block 472. Similarly, if the determination made at decision block 468 is NO, processing continues to decision block 472. At decision block 472, a determination is made whether the received authentication datum matches a known authentic value of a corresponding authentication datum. If this determination is YES, processing continues to decision block 476 where a determination is made whether the elapsed time calculated at process block 470 exceeds a threshold value. This threshold value can be determined by an administrator of the computing resource for which access is sought. One possible threshold value is one second. Fractions of seconds, multiple seconds, or other periods of time can also be used.

If the determination made at decision block 472 is NO, processing continues to process block 474 where access to the computing resource is denied. If the determination made at decision block 476 is NO, processing also continues to process block 474. If the determination made at decision block 476 is YES, processing continues to decision block 478.

At decision block 478, a determination is made whether a complete set of access credentials has been received. This determination can be made by counting the number of authentication datums received and comparing that number to the number of stored and known authentic datums. Additionally or alternatively, this determination can be made by detecting a termination character such as an end of line (EOL) character, an end of file (EOF) character, a NULL character, a line feed (LF) character, a carriage return (CR) character, a combined LF/CR character, or another suitable terminator.

If determination made at decision block 478 is NO, processing continues to process block 460. If this determination is YES, processing continues to process block 480 where access to the computing resource is permitted. Processing from either process block 474 or process block 480 continues to END block 490 where processing of the method 450 terminates.

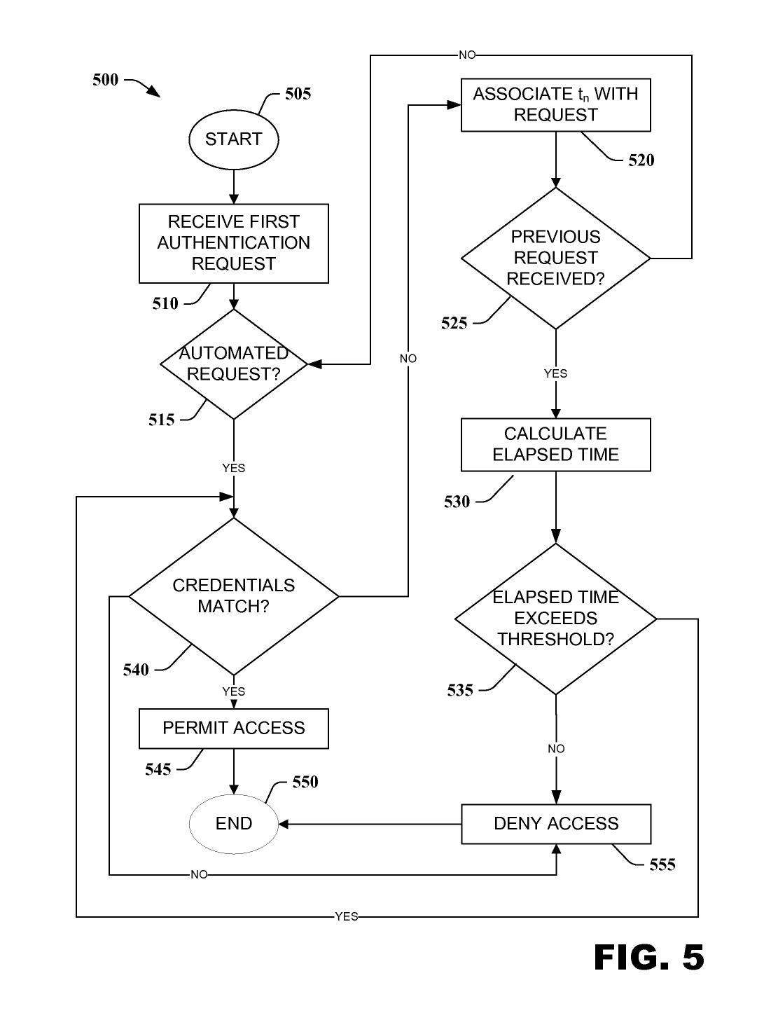

FIG. 5 is a flow diagram for a method 500 of authenticating a user of a computing resource. Processing of the method 500 begins at START block 505 and continues to process block 510. At process block 510 a first request to authenticate a user of a computing resource is received. Processing continues to decision block 515 where a determination is made whether the request to authenticate a user originated from an automated login procedure such as a username-password storage feature found in many web browsers or other software applications.

If the determination made at decision block 515 is NO, processing continues to process block 520 where a time indicator, such as a time stamp based on terrestrial time or another suitable time indicator, is associated with the first request to authenticate a user. Processing continues at decision block 525 where a determination is made whether a previous request to authenticate the user was received. If this determination is YES, processing continues at process block 530 where an elapsed time between authentication requests is calculated by subtracting the value of the time information of the most recent prior authentication request from the value of the time information of the current authentication request.

Processing continues at decision block 535 where a determination is made whether the elapsed time calculated at process block 530 exceeds a threshold value. If YES, processing continues to decision block 540 where a determination is made whether the access credentials presented as part of an authentication request match a known authentic set of access credentials. If this determination is YES, processing continues to process block 545 where access to the computing resource is permitted. Processing concludes at END block 550.

If either the determination made at decision block 540 is NO or the determination made at decision block 535 is NO, processing continues at process block 555 where access to the computing resource is denied. Processing from process block 555 continues to END block 550 where processing of the method 500 concludes.

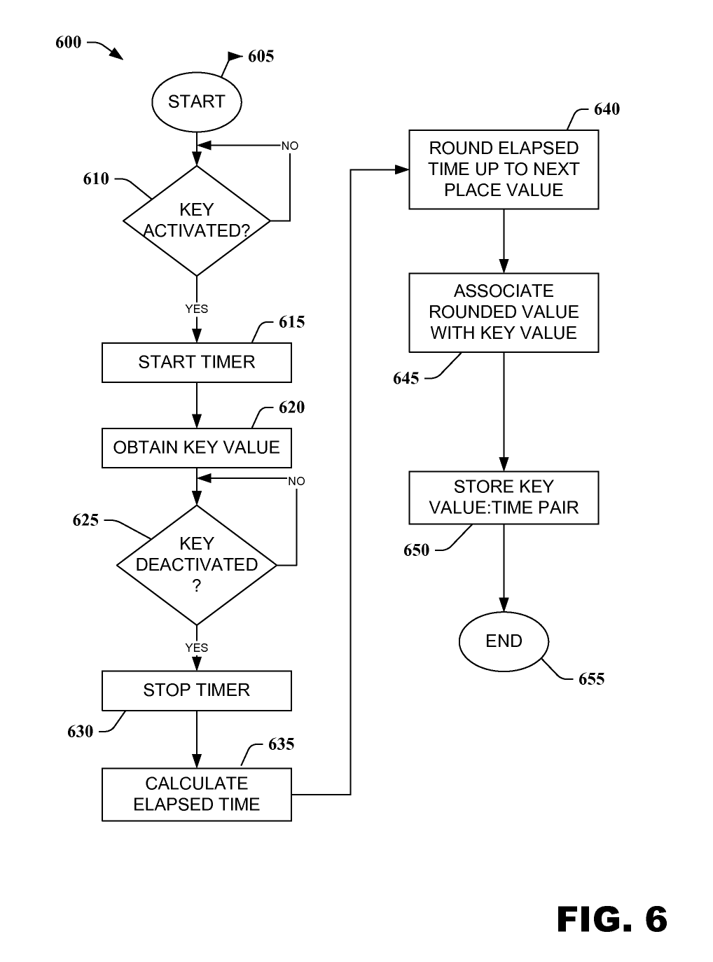

FIG. 6 is a flow diagram for a method 600 of creating authentication credentials with time attributes. Processing of the method 600 begins at START block 605 and continues to decision block 610. At decision block 610, a determination is made whether a key on an input device has been activated by depression, selection, or other manner. If the determination is NO, processing continues to loop at decision block 610. If the determination is YES, processing continues to process block 615 where a timer is started.

Processing continues to process block 620 where a value associated with the key is obtained. At decision block 625, a determination is made whether the previously selected key has been deselected. If this determination is NO, processing continues to loop at decision block 625. If this determination is YES, processing continues to process block 630 where the timer that was started at process block 615 is stopped.

At process block 635, an elapsed time is calculated by reading the timer value or by calculating the absolute value of the difference between time values at the start point and stop point. Processing continues at process block 640 where the value of the elapsed time is rounded to the next value place. Various rounding schemes can be used, such as always rounding up to the next value place, always rounding down to the next value place, or alternatively rounding up or down to the next value place.

Additionally or alternatively, another rounding technique can be used. A value place to which the elapsed time value is rounded can be selected based on a variety of factors. A whole number place value, such as ones, tens, hundreds, or thousands can be used. A decimal fraction, such as tenths, hundredths, or thousandths can also be used. It should be noted that the place value chosen can depend at least in part upon the unit of time being used.

At process block 650, the key value obtained at process block 620 and the rounded elapsed time value are stored as a value:time pair for inclusion in a set of authentication credentials. Processing concludes at END block 655.

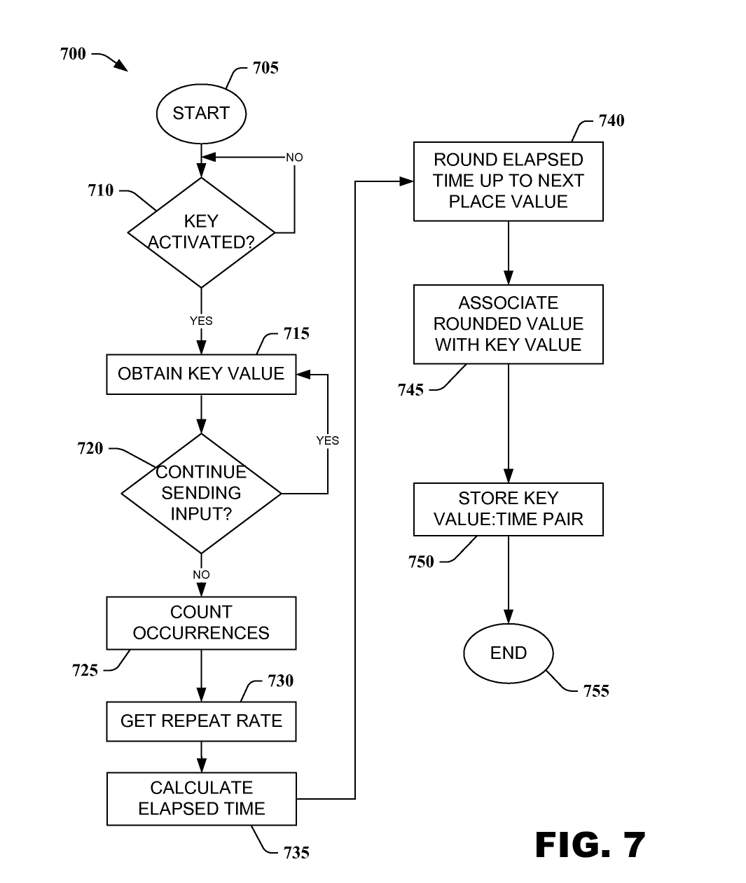

FIG. 7 is a flow diagram for a method 700 of creating authentication credentials with time attributes. Processing of the method 700 begins at START block 705 and continues to decision block 710. At decision block 710, a determination is made whether a key on an input device has been activated by depression, selection, or other manner. If the determination is NO, processing continues to loop at decision block 710. If the determination is YES, processing continues to process block 715 where a value associated with the activated key is obtained. At decision block 720, a determination is made whether the activated key is continuing to send its input value. If this determination is YES, processing continues to process block 715. If this determination is NO, processing continues to process block 725.

At process block 725, occurrences of the key value obtained at process block 715 are counted. Processing continues to process block 730 where a key value repeat rate is obtained. This repeat rate can be obtained from a device driver, an operating system component that manages input from the input device, or from another suitable source.

At process block 735, an elapsed time is calculated by dividing the number of occurrences obtained at process block 725 by the repeat rate obtained at process block 730. Processing continues to process block 740 where the value of the elapsed time is rounded to the next value place. Various rounding schemes can be used, such as always rounding up to the next value place, always rounding down to the next value place, or alternatively rounding up or down to the next value place.

Additionally or alternatively, another rounding technique can be used. A value place to which the elapsed time value is rounded can be selected based on a variety of factors. A whole number place value, such as ones, tens, hundreds, or thousands can be used. A decimal fraction, such as tenths, hundredths, or thousandths can also be used. It should be noted that the place value chosen can depend at least in part upon the unit of time being used.

At process block 745, the key value obtained at process block 715 is associated with the rounded elapsed time value calculated at process block 740 to create a value:time pair. At process block 750, the value:time pair is stored for inclusion in a set of authentication credentials. Processing of the method 700 concludes at END block 755.

The preceding descriptions of various components and methods are intended to illustrate specific examples and describe certain ways of making and using the devices disclosed and described here. These descriptions are neither intended to be nor should be taken as an exhaustive list of the possible ways in which these components can be made and used. A number of modifications, including substitutions of components between or among examples and variations among combinations can be made. Those modifications and variations should be apparent to those of ordinary skill in this area after having read this document.

1. A computer-implemented method for controlling access to a computing resource, comprising the steps of:
receiving a first authentication datum;
determining a first time associated with the first authentication datum;
receiving a second authentication datum;
determining a second time associated with the second authentication datum;
calculating a first datum elapsed time between the second time associated with the second authentication datum and the first time associated with the first authentication datum; and
selectively providing access to a computing resource based at least in part upon
successfully matching the received first authentication datum with a stored first authentication datum,
successfully matching the received second authentication datum with a stored second authentication datum, and
comparing the first datum elapsed time with a datum threshold time.

2. The computer-implemented method of claim 1, wherein each authentication datum is an authentication datum selected from the group consisting of an alphanumeric character, an alphanumeric string, a binary string, a data file, and a data object.

3. The computer-implemented method of claim 2, wherein the computing resource is a resource selected from the group consisting of a local computer, a remote computer, a mobile computing device, a network management device, a software program, a software-based service, a data store, and a file.

4. The method of claim 3, further comprising the steps of:
receiving a first request to access the computing resource;
determining a first access request time associated with the first request to access the computing resource;
receiving a second request to access the computing resource;
determining a second access request time associated with the second request to access the computing resource;
calculating an access request elapsed time between the second access request time associated with the second request to access the computing resource and the first access request time associated with the first request to access the computing resource; and
selectively denying access to the computing resource based at least in part upon determining that the access request elapsed time fails to exceed an access request threshold time.

5. The computer-implemented method of claim 4, further comprising the step of detecting whether the first authentication datum originated from a stored credential system.

6. The computer-implemented method of claim 5, wherein at least one of the steps of
determining a first time associated with the first authentication datum;
determining a second time associated with the second authentication datum;
calculating a first datum elapsed time between the second time associated with the second authentication datum and the first time associated with the first authentication datum; and
selectively providing access to a computing resource based at least in part upon
successfully matching the received first authentication datum with a stored first authentication datum,
successfully matching the received second authentication datum with a stored second authentication datum, and
comparing the first datum elapsed time with a datum threshold time
is performed subsequent to a first denial of access to the computing resource.

7. The method of claim 1, further comprising the steps of:
receiving a third authentication datum;
determining a third time associated with the third authentication datum;
calculating a second datum elapsed time between the third time associated with the third authentication datum and the second time associated with the second authentication datum; and
wherein the step of selectively providing access to a computing resource includes the step of determining whether the second datum elapsed time is greater than the datum threshold time.

8. The computer-implemented method of claim 7, wherein each authentication datum is an authentication datum selected from the group consisting of an alphanumeric character, an alphanumeric string, a binary string, a data file, and a data object.

9. The computer-implemented method of claim 8, wherein the computing resource is a resource selected from the group consisting of a local computer, a remote computer, a mobile computing device, a network management device, a software program, a software-based service, a data store, and a file.

10. The computer-implemented method of claim 9, further comprising the steps of:
receiving a first request to access the computing resource;
determining a first access request time associated with the first request to access the computing resource;
receiving a second request to access the computing resource;
determining a second access request time associated with the second request to access the computing resource;
calculating an access request elapsed time between the second access request time associated with the second request to access the computing resource and the first access request time associated with the first request to access the computing resource; and
selectively denying access to the computing resource based at least in part upon determining that the access request elapsed time fails to exceed an access request threshold time.

11. The computer-implemented method of claim 10, further comprising the step of detecting whether the first authentication datum originated from a stored credential system.

12. The computer-implemented method of claim 11, wherein at least one of the steps of
determining a first time associated with the first authentication datum;
determining a second time associated with the second authentication datum;
determining a third time associated with the third authentication datum;
calculating a first datum elapsed time between the second time associated with the second authentication datum and the first time associated with the first authentication datum;
calculating a second datum elapsed time between the third time associated with the third authentication datum and the second time associated with the second authentication datum; and
determining whether the first datum elapsed time is greater than a datum threshold time;
determining whether the second datum elapsed time is greater than the datum threshold time,
is performed subsequent to a first denial of access to the computing resource.

13. A computer-implemented method for creating authentication credentials to access a computing resource, comprising the steps of:
detecting activation of an input key;
obtaining a data value assigned to the input key;
determining a duration of activation of the input key; and
associating the duration of activation of the input key with the data value assigned to the input key.

14. The computer-implemented method of claim 13, further comprising the step of
repeating one or more times the steps of
detecting activation of an input key;
obtaining a data value assigned to the input key;
determining a duration of activation of the input key; and
associating the duration of activation of the input key with the data value assigned to the input key
to create a complete set of authentication credentials.

15. The computer-implemented method of claim 14, wherein the data value assigned to the input key is an alphanumeric character.

16. The computer-implemented step of claim 15, wherein the step of determining a duration of activation of the input key includes the step of counting repeated occurrences of the alphanumeric character and calculating the duration of activation using at least a repeat rate of keyed data input.

17. The computer-implemented step of claim 15, wherein the step of determining a duration of activation of the input key includes the step of using a clock to calculate a time interval between activation of the input key and deactivation of the input key.

18. An apparatus for managing access to a computing resource, comprising:
a clock configured to associate a datum arrival time with an authentication datum and further configured to calculate a datum elapsed time between a first datum arrival time associated with a first authentication datum and a second datum arrival time associated with a second authentication datum;
an authentication module configured to receive at least the first authentication datum and the second authentication datum,
compare the datum elapsed time with a threshold elapsed time,
and selectively provide access to a computing resource based at least in part upon
successfully matching the received first authentication datum with a stored first authentication datum,
successfully matching the received second authentication datum with a stored second authentication datum, and
determining that the datum elapsed time exceeds the datum threshold time.

19. The apparatus of claim 18, wherein each authentication datum is an authentication datum selected from the group consisting of an alphanumeric character, an alphanumeric string, a binary string, a data file, and a data object.

20. The apparatus of claim 19, wherein the computing resource is a resource selected from the group consisting of a local computer, a remote computer, a mobile computing device, a network management device, a software program, a software-based service, a data store, and a file.

21. The apparatus of claim 20, wherein
the clock is further configured to
associate an access request time with a request to access the computing resource and
calculate an access request elapsed time between a first access request time associated with a first access request and a second access request time associated with a second access request and
the authentication module is further configured to selectively deny access based at least in part upon a comparison of the access request elapsed time with an access request threshold time.

22. The apparatus of claim 21, wherein the authentication module is further configured to determine whether at least one of the first authentication datum and the first access request originated from a stored credential system.

23. An apparatus for creating authentication credentials, comprising:
an authentication module configured to create a set of authentication credentials by
detecting activation of an input key;
obtaining a data value assigned to the input key;
determining a duration of activation of the input key;
associating the duration of activation of the input key with the data value assigned to the input key; and
repeating, zero or more times, the steps of detecting, obtaining, determining, and associating, and
storing a set of authentication credentials that include at least one data value assigned to the input key and an associated duration of activation.

24. The apparatus of claim 23, further comprising a user interface configured to display both the data value assigned to the input key and the duration of activation associated with the data value.

25. The apparatus of claim 23, further comprising a user interface configured to display both
an obfuscation symbol in place of the data value assigned to the input key and
the duration of activation associated with the data value.

26. A computer-implemented method for accessing a computing resource, comprising:
sending a first authentication datum that includes a first value:time pair;
sending a second authentication datum that includes a second value:time pair; and
receiving an access indicator that indicates whether access is granted to a computing resource;
wherein the access indicator is created based at least in part upon
calculating a first datum elapsed time the time of the second value:time pair and the time of the first value:time pair;
successfully matching the received first authentication datum with a stored first authentication datum,
successfully matching the received second authentication datum with a stored second authentication datum, and
comparing the first datum elapsed time with a datum threshold time.

27. The computer-implemented method of claim 26, wherein each value portion of the first value:time pair and the second value:time pair is a value selected from the group consisting of an alphanumeric character, an alphanumeric string, a binary string, a data file, and a data object.

28. The computer-implemented method of claim 27, wherein the computing resource is a resource selected from the group consisting of a local computer, a remote computer, a mobile computing device, a network management device, a software program, a software-based service, a data store, and a file.

29. An apparatus for accessing a computing resource, comprising:
an authentication module configured to send a first authentication datum that includes a first value:time pair and a second authentication datum that includes a second value:time pair; and further configured to receive an access indicator that indicates whether access is granted to a computing resource;
wherein the access indicator is created based at least in part upon
calculating a first datum elapsed time the time of the second value:time pair and the time of the first value:time pair;
successfully matching the received first authentication datum with a stored first authentication datum,
successfully matching the received second authentication datum with a stored second authentication datum, and
comparing the first datum elapsed time with a datum threshold time.

30. The apparatus of claim 29, wherein each value portion of the first value:time pair and the second value:time pair is a value selected from the group consisting of an alphanumeric character, an alphanumeric string, a binary string, a data file, and a data object.

31. The apparatus of claim 30, wherein the computing resource is a resource selected from the group consisting of a local computer, a remote computer, a mobile computing device, a network management device, a software program, a software-based service, a data store, and a file.
